(19) United States
(12) Patent Application Publication
(10) Pub. No.: US 2014/0248146 A1
(43) Pub. Date: Sep. 4, 2014

(54) ATTACHMENT APPARATUS FOR CERAMIC MATRIX COMPOSITE MATERIALS

(71) Applicant: United Technologies Corporation, Hartford, CT (US)

(72) Inventors: David J. Sander, South Windsor, CT (US); Shelton O. Duelm, Wethersfield, CT (US)

(21) Appl. No.: 13/919,373

(22) Filed: Jun. 17, 2013

Related U.S. Application Data
(63) Continuation-in-part of application No. 13/600,781, filed on Aug. 31, 2012.

(51) Int. Cl. F16B 33/00; F02C 7/20

(52) U.S. Cl. CPC F16B 33/004; F02C 7/20
USPC 415/213.1; 29/889.2; 411/360

(57) ABSTRACT

A first ceramic matrix composite structure having a first flange with a first aperture, and a second structure having a second flange with a second aperture are clamped together by a fastener and spring assembly. The second flange is in contact with the first flange and the apertures of the first and second flanges align with each other. A threaded fastener having a thermal expansion rate that is different than the thermal expansion rate of at least one of the first ceramic matrix composite structure and second structure extends through the aligned apertures. The fastener includes a bolt, a nut, and a spring assembly that maintains a constant clamping pressure irrespective of the thermal expansion differences between the bolt and the first ceramic matrix composite structure and second structure.

### CROSS-REFERENCE TO RELATED APPLICATION

This application is a continuation-in-part to application Ser. No. 13/600,781, filed on Aug. 31, 2012, and entitled “Attachment Apparatus for Ceramic Matrix Composite Materials,” the disclosure of which is incorporated by reference in its entirety.

### BACKGROUND

The present invention relates to the field of gas turbine engines, and more particularly to an attachment apparatus for ceramic matrix composite materials in a gas turbine engine.

A typical gas turbine engine operates in an extremely harsh environment characterized by very high temperatures and vibrations. A conventional gas turbine engine includes a compressor for compressing entering air, a combustor for mixing and burning the compressed gases that emerge from the compressor with fuel, a turbine for expanding the hot gases to generate thrust to propel the engine, and an exhaust nozzle for allowing hot gases to exit the engine. Thus, the exhaust nozzle must accommodate extremely hot gases exiting the engine.

Other considerations critical to engine design are avoiding air leakage and insulating certain engine components from exposure to hot gases. One type of a material that withstands hot temperatures is ceramic matrix composite (CMC) material. However, it is difficult to attach the CMC material components with a metal fastening material. One obstacle to attaching CMC materials with metal is the different thermal expansions of the materials. In general, it is difficult to attach or join different materials in a gas turbine engine due to different thermal expansion properties.

### SUMMARY

An apparatus includes a first ceramic matrix structure and second structure that are joined together by a fastener of a different material. The first ceramic matrix structure has a first flange with a first aperture. A second structure has a second flange with a second aperture. The second flange is in contact with the first flange and the apertures of the first and second flanges are aligned with each other. The aligned apertures contain a threaded fastener having a thermal expansion rate that is different than the thermal expansion rate of at least one of the first ceramic matrix composite structure and the second structure. The fastener includes a spring assembly that maintains a constant clamping pressure irrespective of the thermal expansion differences between the bolt and at least one of the first ceramic matrix composite structure and the second structure.

Another embodiment is a mid-turbine frame located in a gas turbine engine, the mid-turbine frame includes a ceramic matrix composite component that has a first flange with an aperture. A second component has a flange with an aperture that aligns with the aperture from the first flange. A bolt with a different thermal expansion rate than at least one of the first ceramic matrix composite component and the second component extends through the apertures. The bolt has a head and a threaded shank. A nut is threadingly engaged onto the threaded portion of the bolt shank. A spring assembly is disposed on the bolt shank between the bolt head and the flanges that maintains a substantially constant clamping pressure irrespective of thermal expansion differences between the bolt and at least one of the first ceramic matrix composite component and the second component of the mid-turbine frame.

Another embodiment is a method of assembling a mid-turbine frame for use in a gas turbine engine. The method includes positioning a first flange of a first ceramic matrix composite component of the mid-turbine frame so that it abuts a second flange of a second component of the mid-turbine frame. The first and second flanges of the first ceramic matrix composite component and the second component are attached together via a fastener with a spring assembly. The fastener is tightened to cause the spring assembly to apply a force that clamps the first and second flanges together.

### BRIEF DESCRIPTION OF THE DRAWINGS

FIG. 1 is a schematic view of a gas turbine engine.

FIG. 2 is a cross-sectional view of a portion of a gas turbine engine.

FIG. 3 is a cross-sectional view of a portion of a first vane adjoining a portion of a second vane.

FIG. 4 is a schematic cross-sectional view of ceramic matrix composite structures being compressed by a fastener according to a second embodiment.

FIG. 5 is a schematic cross-sectional view of ceramic matrix composite structures being compressed by a fastener according to a third embodiment.

FIG. 6 is a schematic cross-sectional view of ceramic matrix composite structures being compressed by a fastener according to a fourth embodiment.

FIG. 7 shows a schematic cross-sectional view of ceramic matrix composite structures being compressed by a fastener according to a fifth embodiment.

### DETAILED DESCRIPTION

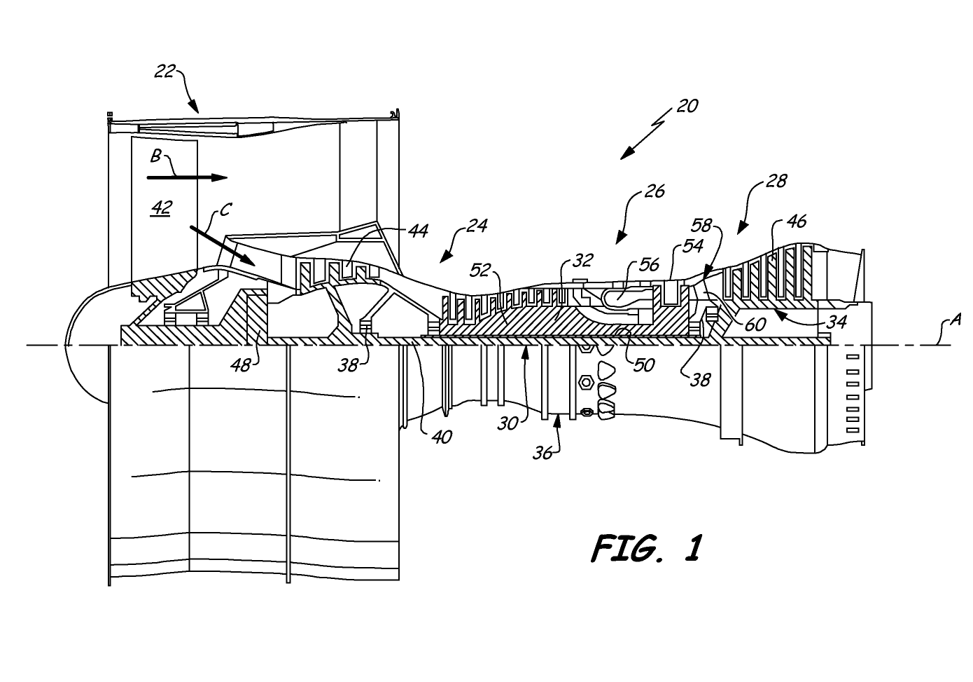

FIG. 1 schematically illustrates an example gas turbine engine 20 that includes fan section 22, compressor section 24, combustor section 26 and turbine section 28. Alternative engines might include an augmenter section (not shown) among other systems or features. Fan section 22 drives air along bypass flow path B while compressor section 24 draws air in along core flow path C where air is compressed and communicated to combustor section 26. In combustor section 26, air is mixed with fuel and ignited to generate a high pressure exhaust gas stream that expands through turbine section 28 where energy is extracted and utilized to drive fan section 22 and compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes low speed spool 30 and high speed spool 32 mounted for rotation about an engine central longitudinal axis A relative to an engine static structure 36 via several bearing systems 38. It should be understood that various bearing systems 38 at various locations may alternatively or additionally be provided.

Low speed spool 30 generally includes inner shaft 40 that connects fan 42 and low pressure (or first) compressor section 44 to low pressure (or first) turbine section 46. Inner shaft 40 drives fan 42 through a speed change device, such as geared architecture 48, to drive fan 42 at a lower speed than low speed spool 30. High-speed spool 32 includes outer shaft 50 that interconnects high pressure (or second) compressor section 52 and high pressure (or second) turbine section 54. Inner shaft 40 and outer shaft 50 are concentric and rotate via bearing systems 38 about engine central longitudinal axis A.

Combustor 56 is arranged between high pressure compressor 52 and high pressure turbine 54. In one example, high pressure turbine 54 includes at least two stages to provide a double stage high pressure turbine 54. In another example, high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about five (5). The pressure ratio of the example low pressure turbine 46 is measured prior to an inlet of low pressure turbine 46 as related to the pressure measured at the outlet of low pressure turbine 46 prior to an exhaust nozzle.

Mid-turbine frame 58 of engine static structure 36 is arranged generally between high pressure turbine 54 and low pressure turbine 46. Mid-turbine frame 58 further supports bearing systems 38 in turbine section 28 as well as setting airflow entering low pressure turbine 46.

The core airflow C is compressed by low pressure compressor 44 then by high pressure compressor 52 mixed with fuel and ignited in combustor 56 to produce high speed exhaust gases that are then expanded through high pressure turbine 54 and low pressure turbine 46. Mid-turbine frame 58 includes vanes 60, which are in the core airflow path and function as an inlet guide vane for low pressure turbine 46. Utilizing vane 60 of mid-turbine frame 58 as the inlet guide vane for low pressure turbine 46 decreases the length of low pressure turbine 46 without increasing the axial length of mid-turbine frame 58. Reducing or eliminating the number of vanes in low pressure turbine 46 shortens the axial length of turbine section 28. Thus, the compactness of gas turbine engine 20 is increased and a higher power density may be achieved.

The disclosed gas turbine engine 20 in one example is a high-bypass geared aircraft engine. In a further example, gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, gas turbine engine 20 includes a bypass ratio greater than about ten (10:1) and the fan diameter is significantly larger than an outer diameter of low pressure compressor 44. It should be understood, however, that the above parameters are only exemplary of one embodiment of a gas turbine engine including a geared architecture and that the present disclosure is applicable to other gas turbine engines.

A significant amount of thrust is provided by bypass flow B due to the high bypass ratio. Fan section 22 of engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/518.7]^{0.5}. The “Low corrected fan tip speed”, as disclosed herein according to one non-limiting embodiment, is less than about 1150 ft/second.

The example gas turbine engine includes fan 42 that comprises in one non-limiting embodiment less than about twenty-six fan blades. In another non-limiting embodiment, fan section 22 includes less than about twenty fan blades. Moreover, in one disclosed embodiment low pressure turbine 46 includes no more than about six turbine rotors schematically indicated at 34. In another non-limiting example embodiment low pressure turbine 46 includes about three turbine rotors. A ratio between number of fan blades 42 and the number of low pressure turbine rotors is between about 3.3 and about 8.6. The example low pressure turbine 46 provides the driving power to rotate fan section 22 and therefore the relationship between the number of turbine rotors 34 in low pressure turbine 46 and number of blades 42 in fan section 22 disclose an example gas turbine engine 20 with increased power transfer efficiency.

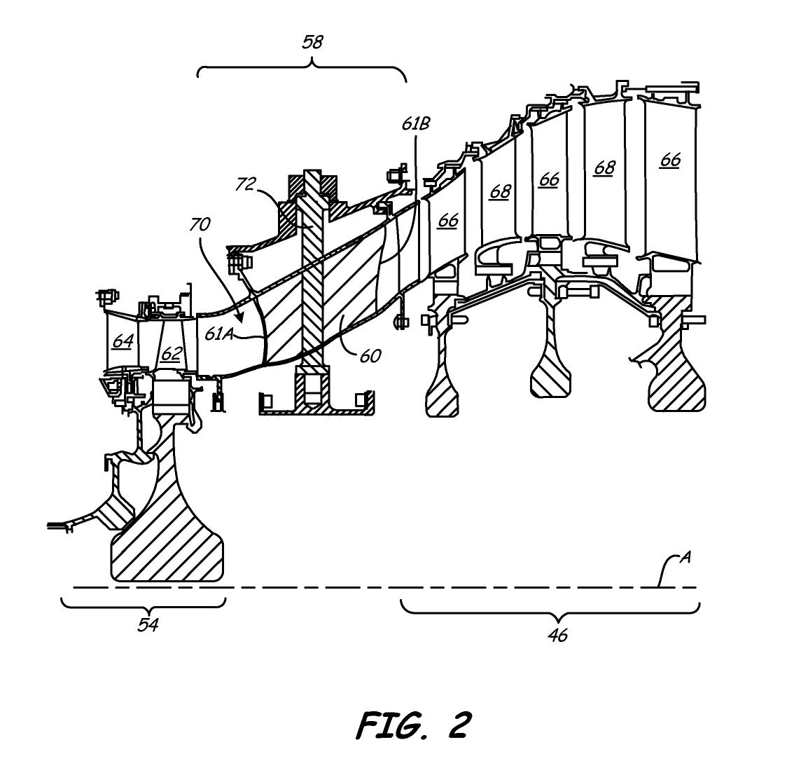

FIG. 2 shows a cross-sectional view of a portion of the gas turbine engine 20 near the mid-turbine frame 58. As shown in FIG. 2, the high pressure (or second) turbine section 54 includes a number of rotating blades 62 and a number of non-rotating vanes 64, and the low pressure (or first) turbine section 46 includes a number of rotating, shrouded blades 66 and a number of non-rotating vanes 68. It should be noted that the present invention is applicable to engines that utilize shrouded and/or unshrouded airfoils. The mid-turbine frame assembly 58 includes a duct 70, a number of non-rotating vanes 60 (only one vane 60, shown in partial cross-section is visible in FIG. 2), and a strut 72. The components of the mid-turbine frame 58 can be formed of a metallic material. The vanes 60 of the mid-turbine frame 58 are airfoil-shaped and arranged as a cascade in order to guide airflow passing through the duct 70, though only one vane 60 is visible in the cross-section of FIG. 2. Each vane 60 has a leading edge 61A and an opposite trailing edge 61B. The particular aerodynamic shape of the vanes 60 can vary as desired for particular applications.

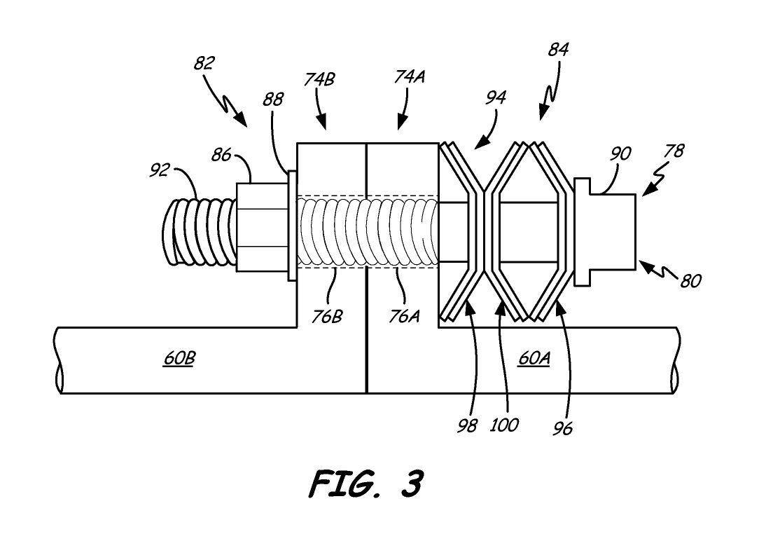

FIG. 3 is a cross-sectional view of a portion of a first vane 60A adjoining a portion of a second vane 60B. The first vane 60A is made up of a first ceramic matrix composite structure and the second vane 60B is made up of a second ceramic matrix composite structure. A first flange 74A extends from the first vane 60A. A second flange 74B extends from the second vane 60B. The two flanges 74A and 74B contain apertures 76A and 76B, respectively. A fastener 78 compresses the two flanges 74A and 74B together. The fastener 78 includes a bolt 80, a nut 82, and a spring assembly 84. The nut 82 contains a head 86 and a flange 88. The bolt 80 contains a head 90 and a threaded shank 92. The spring assembly 84 is positioned on the bolt 80 between the bolt head 90 and the first flange 74A. The bolt 80 extends through the apertures 76A and 76B of the two flanges 74A and 74B. The nut 82 threadingly engages the threaded bolt shank 92 protruding through the two flanges 74A and 74B and compresses the two flanges 74A and 74B against the force of the spring assembly 84. Functionally, the spring assembly 84 maintains a uniform pressure on the two flanges 74A and 74B. The spring assembly 84 is used to maintain a pre-load force on the two flanges 74A and 74B.

Spring assembly 84 can be made up of Belleville washers or other types of springs. Spring assembly 84 can consist of one or multiple Belleville washers. The Belleville washers can be in series or parallel. The spring rate is tailored by the number and configuration of the Belleville washers.

According to the present embodiment of FIG. 3, the spring assembly 84 includes six Belleville washers 94. The two Belleville washers 96 located nearest the bolt head 90 are facing concave away from the bolt head 90 and concave towards the two flanges 74A and 74B. The two Belleville washers 98 located nearest the two flanges 74A and 74B are facing concave away from the bolt head 90 and concave towards the two flanges 74A and 74B. The two Belleville washers 100, located in between the Belleville washers 96 located nearest the bolt head 90 and the Belleville washers 98 located nearest the two flanges 74A and 74B, are oriented to face concave towards the bolt head 90 and concave away from the two flanges 74A and 74B. Although this embodiment shows six Belleville washers 94, other combinations may include more or fewer Belleville washers 94 oriented in the same direction as the Belleville washers 94 shown in FIG. 3.

The pre-load force on the two flanges 74A and 74B may be adjusted by varying the size, quantity, and configuration of Belleville washers 94; the length of the bolt 80; and the torque applied to fastener 78. The size, quantity, and configuration of Belleville washers 94 are selected to provide the necessary clamping force required throughout engine operation, while remaining in a linear spring resiliency range. The load provided by Belleville washers 94 is therefore consistent for all operating conditions, regardless of thermal growth in fastener 78 and bolt stack members.

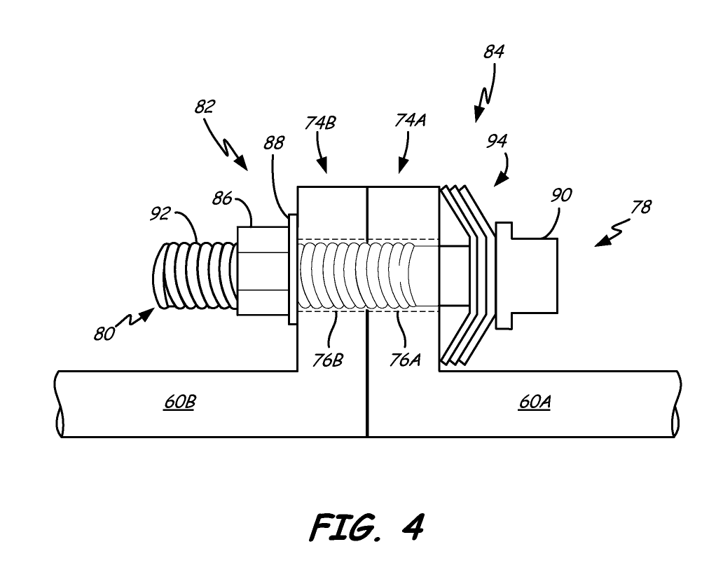

FIG. 4 shows a schematic cross-sectional view of ceramic matrix composite structures being compressed by a fastener 78 according to a second embodiment. According to this embodiment, the spring assembly 84 includes three Belleville washers 94. The Belleville washers 94 are facing concave away from the bolt head 90 and concave towards the two flanges 74A and 74B. Although this embodiment shows three Belleville washers 94, other combinations may include more or fewer Belleville washers 94 oriented in the same direction as the Belleville washers 94 shown in FIG. 4.

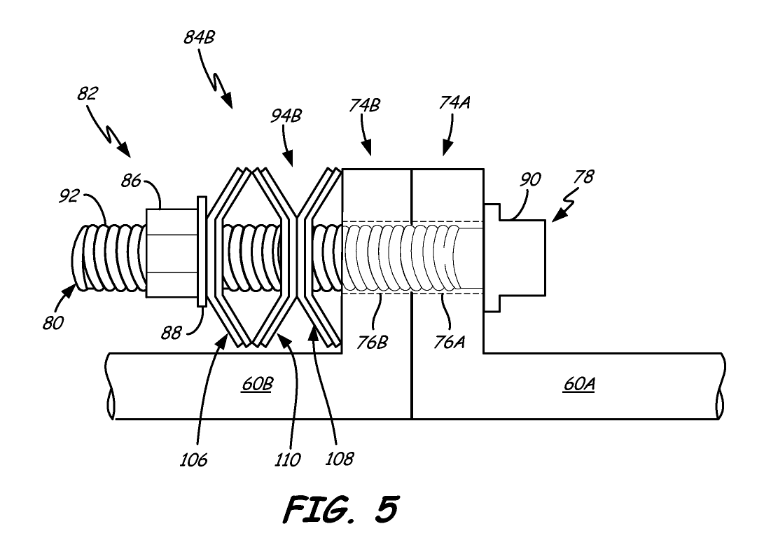

FIG. 5 shows a schematic cross-sectional view of ceramic matrix composite structures being compressed by a fastener 78 according to a third embodiment. According to this embodiment, a spring assembly 84B is positioned on the bolt 80 between the nut 82 and the second flange 74B. The spring assembly 84B includes six Belleville washers 94B. The two Belleville washers 106 located nearest the nut 82 are facing concave away from the nut 82 and concave towards the two flanges 74A and 74B. The two Belleville washers 108 located nearest the two flanges 74A and 74B are facing concave away from the nut 82 and concave towards the two flanges 74A and 74B. The two Belleville washers 110, located in between the Belleville washers 106 located nearest the nut 82 and the Belleville washers 108 located nearest the two flanges 74A and 74B, are oriented to face concave towards the nut 82 and concave away from the two flanges 74A and 74B. Although this embodiment shows six Belleville washers 94B, other combinations may include more or fewer Belleville washers 94B oriented in the same direction as the Belleville washers 94B shown in FIG. 5.

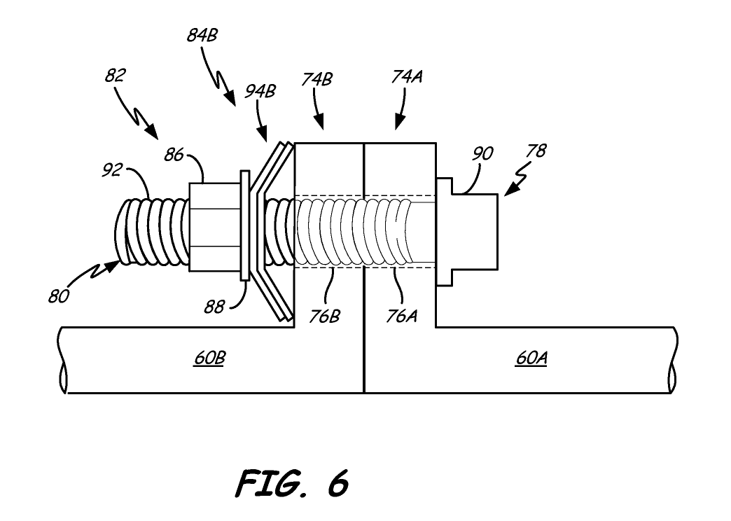

FIG. 6 shows a schematic cross-sectional view of ceramic matrix composite structures being compressed by a fastener 78 according to a fourth embodiment. According to this embodiment, a spring assembly 84B is positioned on the bolt 80 between the nut 82 and the second flange 74B. According to this embodiment, the spring assembly 84B includes three Belleville washers 94B. The Belleville washers 94B are facing concave away from nut 82 and concave towards the two flanges 74A and 74B. Although this embodiment shows three Belleville washers 94B, other combinations may include more or fewer Belleville washers 94B oriented in the same direction as the Belleville washers 94B shown in FIG. 6.

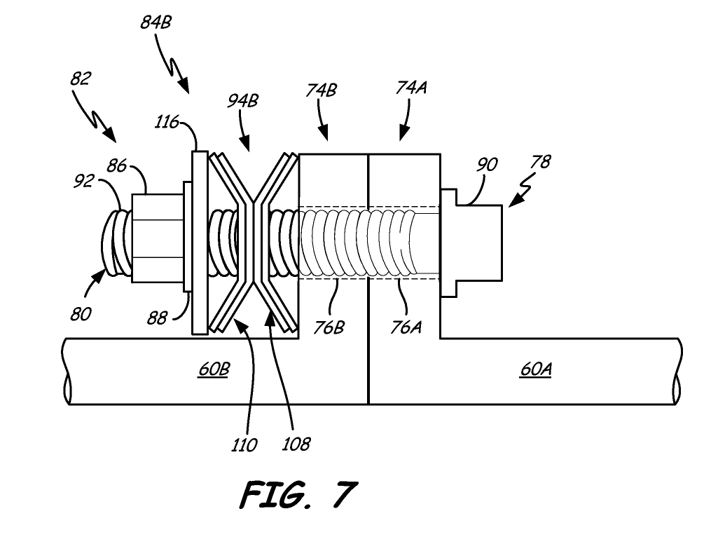

FIG. 7 shows a schematic cross-sectional view of ceramic matrix composite structures being compressed by a fastener 78 according to a fifth embodiment. According to this embodiment, a flat washer 116 is positioned on the bolt 80 between the nut 82 and a spring assembly 84B. The spring assembly 84B includes four Belleville washers 94B. The two Belleville washers 110 located nearest the flat washer 116 are facing concave towards the flat washer 116 and concave away from the two flanges 74A and 74B. The two Belleville washers 108 located nearest the two flanges 74A and 74B are facing concave away from the flat washer 116 and concave towards the two flanges 74A and 74B. Although this embodiment shows one flat washer 116, other combinations may include more flat washers 116 positioned in the same or different locations as the flat washer 116 shown in FIG. 7.

Although the embodiments have been discussed as having both structures (e.g. vanes 60A and 60B) being made of ceramic matrix composite material, the fastener with a spring assembly is also useful where only one of the two structures being joined is a ceramic matrix composite structure.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

Discussion of Possible Embodiments

The following are non-exclusive descriptions of possible embodiments of the present invention.

An apparatus comprising can include a first ceramic matrix composite structure, having a first flange with a first aperture. The apparatus can have a second structure, having a second flange with a second aperture. The second flange can be in contact with the first flange. The second aperture can be aligned with the first aperture. The fastener can have a portion extending through the first aperture of the first flange and the second aperture of the second flange. The fastener can have a thermal expansion rate different than a thermal expansion rate of at least one of the first ceramic matrix composite structure and the second structure. The fastener can include a spring assembly that maintains a clamping pressure irrespective of thermal expansion differences between the fastener and at least one of the first ceramic matrix composite structure and the second structure.

The apparatus of the preceding paragraph can optionally include, additionally and/or alternatively any, one or more of the following features, configurations and/or additional components:

the fastener can include a bolt and a nut;

the bolt can include a bolt head at a first end of the bolt and a threaded shank at a second end opposite the bolt head;

the nut can include a nut body and a flange at one end of the nut body with the flange extending outward from an outer surface of the nut;

the spring assembly can be located on the bolt between either the bolt head and the first flange of the first ceramic matrix composite structure or the nut and the second flange of the second structure;

the spring assembly can include at least one washer;

the spring assembly can include at least one Belleville washer;

the plurality of Belleville washers can include Belleville washers facing in opposite directions; and/or

the second structure can include a ceramic matrix composite material.

A mid-turbine frame located in a gas turbine engine can include a first ceramic matrix composite component of the mid-turbine frame. The first component can have a first flange with a first aperture. The second component can have a second flange with a second aperture. The second flange can be in contact with the first flange with the second aperture aligned with the first aperture. The bolt can extend through the first aperture and the second aperture. The bolt can have a thermal expansion rate different than a thermal expansion rate of at least one of the first ceramic matrix composite component of the mid-turbine frame and the second component of the mid-turbine frame. The bolt can have a head and a bolt shank having a threaded portion. The nut can be threadingly engaged onto the threaded portion of the bolt shank. The spring assembly can be disposed on the bolt shank between either the bolt head and the first flange or the nut and the second flange, that maintains a clamping pressure irrespective of thermal expansion differences between the fastener and at least one of the first ceramic matrix composite component of the mid-turbine frame and the second component of the mid-turbine frame.

The apparatus of the preceding paragraph can optionally include, additionally and/or alternatively any, one or more of the following features, configurations and/or additional components:

the spring assembly can include at least one washer;

the spring assembly can include at least one Belleville washer;

the plurality of Belleville washers can include Belleville washers facing in opposite directions; and/or

the second component can include a ceramic matrix composite material.

A method of assembling a mid-turbine frame for use in a gas turbine engine can include positioning a first flange of a first ceramic matrix composite component of the mid-turbine frame abutting a second flange of a second component of the mid-turbine frame. The first flange of the first ceramic matrix composite component of the mid-turbine frame can be attached to the second flange of the second component of the mid-turbine frame via a fastener having a spring assembly thereon. The fastener to can be tightened to cause the spring assembly to apply a force that clamps the first and second flanges together.

The method of assembling a mid-turbine frame for use in a gas turbine engine of the preceding paragraph can optionally include, additionally and/or alternatively any, one or more of the following features, configurations and/or additional steps:

the fastener can further include a bolt and a nut;

the bolt can include a bolt head at a first end of the bolt and a threaded shank at a second end opposite the bolt head;

the first flange of the first ceramic matrix composite component of the mid-turbine frame can be compressed against the second flange of the second component of the mid-turbine frame by threadingly engaging the nut onto the threaded bolt shank;

the spring assembly can be disposed onto the bolt between either the bolt head and the first flange of the first ceramic matrix composite component of the mid-turbine frame or the nut and the second flange of the second component of the mid-turbine frame;

the second structure can include a ceramic matrix composite material.

1. An apparatus comprising:
a first ceramic matrix composite structure, having a first flange with a first aperture;
a second structure, having a second flange with a second aperture, the second flange being in contact with the first flange with the second aperture aligned with the first aperture; and
a fastener having a portion extending through the first aperture of the first flange and the second aperture of the second flange, the fastener having a thermal expansion rate different than a thermal expansion rate of at least one of the first ceramic matrix composite structure and the second structure; the fastener including a spring assembly that maintains a clamping pressure irrespective of thermal expansion differences between the fastener and at least one of the first ceramic matrix composite structure and the second structure.

2. The apparatus of claim 1, wherein the fastener further includes a bolt and a nut.

3. The apparatus of claim 2, wherein the bolt comprises a bolt head at a first end of the bolt and a threaded shank at a second end opposite the bolt head.

4. The apparatus of claim 2, wherein the nut comprises a nut body and a flange at one end of the nut body with the flange extending outward from an outer surface of the nut.

5. The apparatus of claim 3, wherein the spring assembly is located on the bolt between either the bolt head and the first flange of the first ceramic matrix composite structure or the nut and the second flange of the second structure.

6. The apparatus of claim 3, wherein the spring assembly comprises at least one washer.

7. The apparatus of claim 6, wherein the spring assembly comprises at least one Belleville washer.

8. The apparatus of claim 7, wherein the plurality of Belleville washers include Belleville washers facing in opposite directions.

9. The apparatus of claim 1, wherein the second structure comprises a ceramic matrix composite material.

10. A mid-turbine frame located in a gas turbine engine, the mid-turbine frame comprising:
a first ceramic matrix composite component of the mid-turbine frame, the first component having a first flange with a first aperture;
a second component of the mid-turbine frame, the second component having a second flange with a second aperture, the second flange being in contact with the first flange with the second aperture aligned with the first aperture;
a bolt extending through the first aperture and the second aperture, the bolt having a thermal expansion rate different than a thermal expansion rate of at least one of the first ceramic matrix composite component of the mid-turbine frame and the second component of the mid-turbine frame, the bolt having a head and a bolt shank having a threaded portion;
a nut threadingly engaged onto the threaded portion of the bolt shank; and
a spring assembly disposed on the bolt shank between either the bolt head and the first flange or the nut and the second flange, that maintains a clamping pressure irrespective of thermal expansion differences between the fastener and at least one of the first ceramic matrix composite component of the mid-turbine frame and the second component of the mid-turbine frame.

11. The mid-turbine frame of claim 10, wherein the spring assembly comprises at least one washer.

12. The mid-turbine frame of claim 11, wherein the spring assembly comprises at least one Belleville washer.

13. The mid-turbine frame of claim 12, wherein the plurality of Belleville washers include Belleville washers facing in opposite directions.

14. The mid-turbine frame of claim 10, wherein the second component comprises a ceramic matrix composite material.

15. A method of assembling a mid-turbine frame for use in a gas turbine engine, the method comprising:
positioning a first flange of a first ceramic matrix composite component of the mid-turbine frame abutting a second flange of a second component of the mid-turbine frame;
attaching the first flange of the first ceramic matrix composite component of the mid-turbine frame to the second flange of the second component of the mid-turbine frame via a fastener having a spring assembly thereon; and
tightening the fastener to cause the spring assembly to apply a force that clamps the first and second flanges together.

16. The method of claim 15, wherein the fastener further includes a bolt and a nut.

17. The method of claim 16, wherein the bolt comprises a bolt head at a first end of the bolt and a threaded shank at a second end opposite the bolt head.

18. The method of claim 17, further comprising compressing the first flange of the first ceramic matrix composite component of the mid-turbine frame against the second flange of the second component of the mid-turbine frame by threadingly engaging the nut onto the threaded bolt shank.

19. The method of claim 17, further comprising disposing the spring assembly onto the bolt between either the bolt head and the first flange of the first ceramic matrix composite component of the mid-turbine frame or the nut and the second flange of the second component of the mid-turbine frame.

20. The method of claim 15, wherein the second component comprises a ceramic matrix composite material.
